(19) United States
(12) Patent Application Publication
(10) Pub. No.: US 2006/0235573 A1
(43) Pub. Date: Oct. 19, 2006

(54) Well Pump Controller Unit

(76) Inventor: Walter Franklin Guion, Camarillo, CA (US)

Correspondence Address: MARK DAVID FOX, ESQ., 588 SUTTER STREET, SUITE 555, SAN FRANCISCO, CA, 94102, US

(21) Appl. No.: 10/907,816

(22) Filed: Apr. 15, 2005

(51) Int. Cl. G05D 7/00

(52) U.S. Cl. 700/282; 367/25; 166/250.03; 417/18

(57) ABSTRACT

In the oil production industry one objective of the field operator is to streamline their oil pumping operations for the more efficient production. The current invention is a controller device used to continuously control and optimize oil production from a well. The current invention is used in conjunction with a precise well measuring device, i.e. a device that can precisely measure characteristics of a well at a moment in time, for generating real-time information to be used by the controller device to optimize the rate of oil production.

### BACKGROUND OF THE INVENTION

As described in U.S. patent application Ser. No. 10/907,611. “Acoustic Generator for Distance Sounding”, Guion et al. (hereinafter incorporated by reference and referred to as “Guion et al.”) the acoustic sounding method is one of several methods used in the oil industry to measure and analyze the fluid depth and other characteristics of an oil well. As further described in Guion et al., the acoustic sounding method has not been able to reach its true potential in oil production because of the lack of automation in these well measuring devices. One potential use of the acoustic sounding method that has not been employed to date is in the area of automated production, i.e. its use and application in real-time oil production situations in order to provide optimum oil production from a well.

### BRIEF SUMMARY OF INVENTION

The current invention is a controller device used to continuously control and optimize oil production from a well. The current invention is used in conjunction with a precise well measuring device, i.e. a device that can precisely measure characteristics of a well at a moment in time, such as the Acoustic Generator described in Guion et al., for generating real-time information to be used by the controller device to optimize the rate of oil production and/or lower oil production operating costs.

The current invention creates, monitors, and uses real-time information about the status of a well by the continuous control of an automated acoustic gun, acoustic generator, or similar device and the continuous control of the rate of oil pumping at the well.

The current invention allows the results of real-time information to continuously control the use of the automated well measuring device, to monitor the rate of oil production, to control the rate of well pumping, and to provide real-time and feedback information for the operator to reach higher, or more consistent, oil production rates from an oil well.

The current invention is a component of a real-time control system for oil well operations. The objective of the real-time control system being to optimize oil production from an oil field by providing real-time information to operators and automated control mechanisms in the field. The current invention is a key component to this real time control system because it provides an automated control mechanism used for the individual wells of an oil field.

### BRIEF DESCRIPTION OF DRAWINGS

FIG. 1 is a depiction of the front panel of the Controller Unit.

FIG. 2 is a block diagram showing the various functions performed by the Controller Unit.

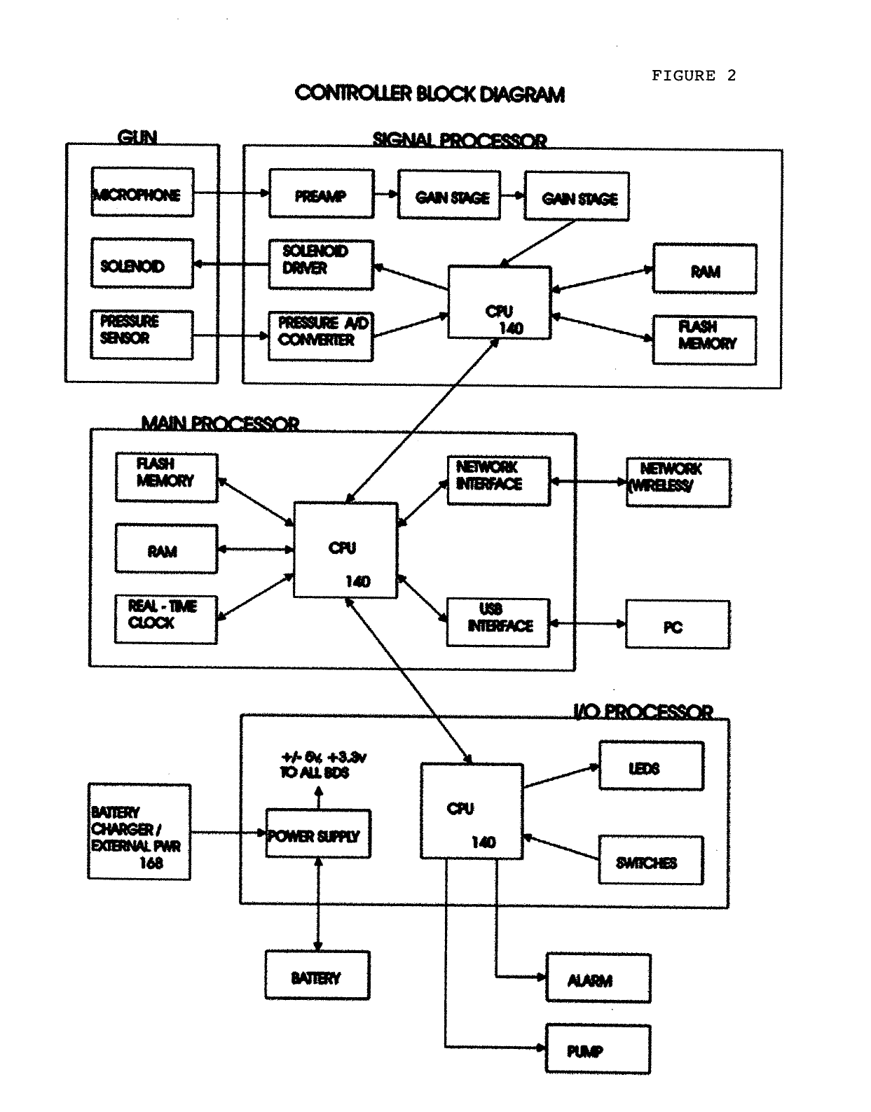

FIG. 3 is the depiction of the results obtained by using a precise well measuring device, the three sections depicting the results obtained at the top, middle and bottom of a typical 12,000 foot oil well.

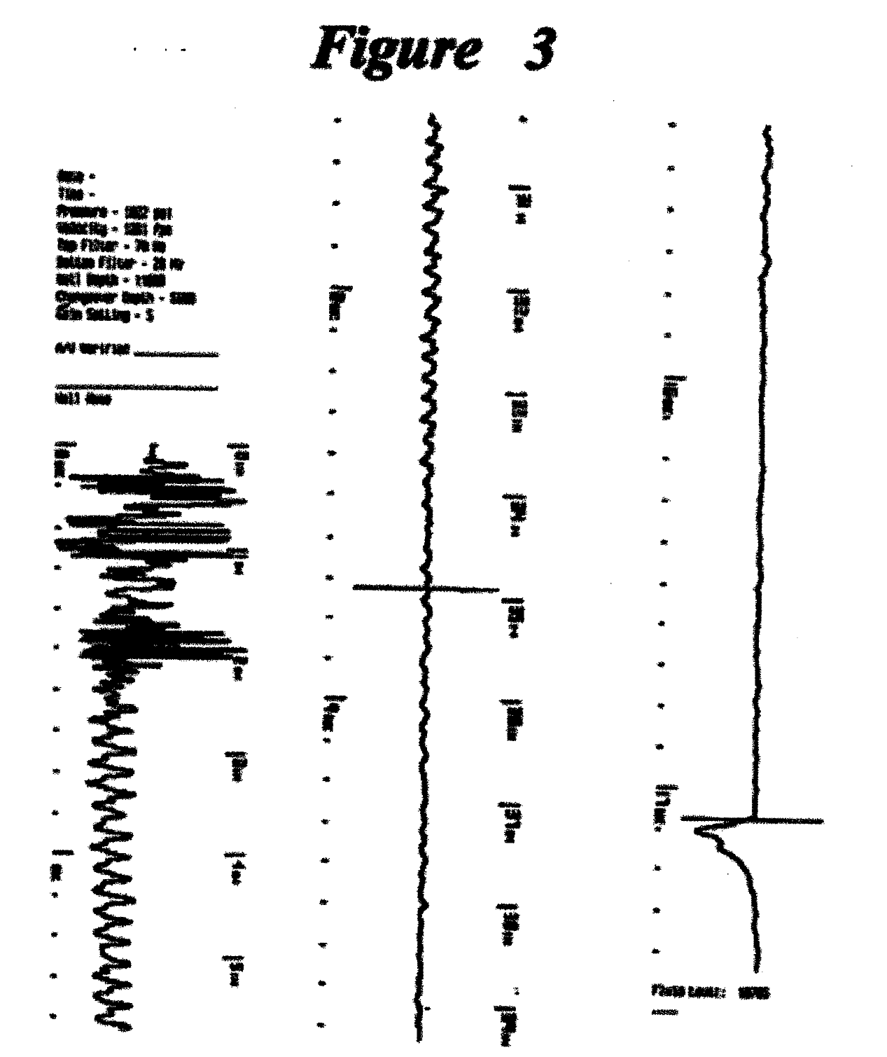

### DETAILED DESCRIPTION OF INVENTION

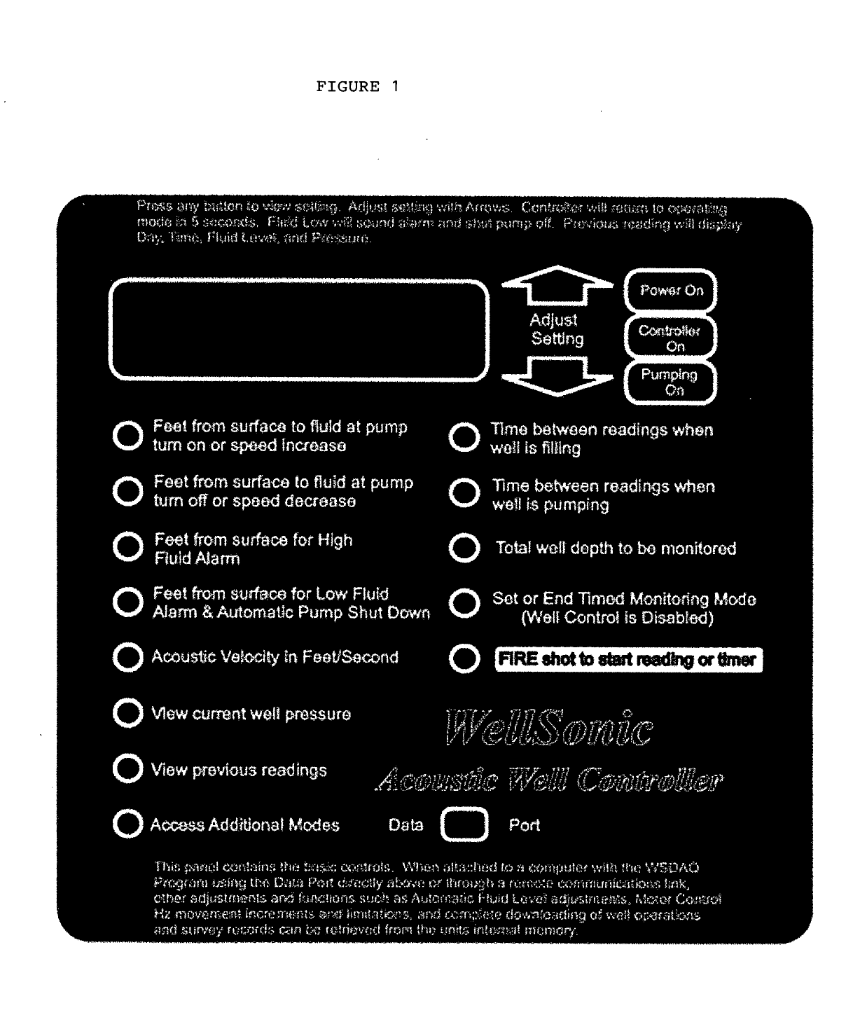

In the preferred embodiment of the current invention described herein the Controller Unit 200 is used with an Acoustic Generator 0 as described in Guion et al. As shown in FIG. 1, the following describes the components and operations of the Controller Unit 200 in a preferred embodiment of the current invention.

In a preferred embodiment of the current invention there are two input signals to, and one output signal from, the Controller Unit 200 to an Acoustic Generator 0. The analog signals from the Acoustic Generator Pressure Transducer 77 are digitalized by the Controller Unit 200 using an A/D Converter 134 for processing by the Controller Unit CPU 140. The analog signal from the Acoustic Generator Microphone 34 is sent to a Preamp 130 and two Gain Stages 136 and 138 in the Controller Unit 200 for input to the CPU 140 where it is digitalized by an A/D converter inside the CPU 140. There are two gain stages to maximize the signal and minimize gain errors although more or less gain stages could be used if needed. The CPU 140 also controls the Acoustic Generator Solenoid 70, which is used to fire the Acoustic Generator 0, by using a Solenoid Driver 132. The Controller Unit CPU 140 has four additional outputs, an output to control the pump, an output to operate an alarm light, an output to interface with a Network Interface 156 (Wireless/SCADA/Etc.), and a USB Interface 154, shown as the USB Port 225 in FIG. 1, to connect the Controller Unit 200 to a computer for further analysis of the data stored in the Controller Unit 200, to download the stored data from the Controller Unit 200, or to send the stored data in the Controller Unit 200 to a remote receiver unit for storage or analysis.

There are two types of memory used in the Controller Unit 200. Flash memory 144 is used for storing long term data such as settings and shot files. Data in a flash memory is not lost when power is removed. Ram memory 142 is used for temporary storage and data is lost when power is removed.

The Pushbutton Switches 165 are momentary switches used to change settings in the Controller Unit 200. The user pushes a switch to select the setting to be changed, then uses the up and down arrows to increase or decrease the original value. A digital signal is sent to the I/O Processor CPU 140 to input settings such as velocity and well depth into the Controller Unit 200.

There are various parameters and functions performed by the CPU 140 which are shown in Table 1 and saved in a Controller shot file. These parameters and functions are:

TABLE 1
Parameters and functions for Controller Unit

well pressure
changeover depth
well depth
velocity
decay rate for fluid level detection
peak averaging time for fluid level detection
threshold multiplier for fluid level detection
decay rate for flag marker detection
peak averaging time for flag marker detection
threshold multiplier for flag marker detection
autostart setting
filter frequencies
preamp gain
minimum gain
maximum gain
start gain setting
end gain setting
upper flag marker window depth
lower flag marker window depth
flag marker depth
chamber pressure
recommended chamber pressure
pump on depth
pump off depth
shot interval - pumping
shot interval - filling
high alarm depth
low alarm depth
date & time of shot
well name
API #
Serial # of controller

In a preferred embodiment of the current invention the Controller Unit 200 uses digital filters. Digital filters are implemented by multiplying the current and previous sound readings by a set of stored coefficients. The output of the filter is the sum of the products. Frequencies, “sharpness” and stop band attenuation are determined by the coefficients used and can be changed by software at any time. The calculations are performed by the CPU 140 so no additional components are needed.

In a preferred embodiment of the current invention the “top” filters filter sound collected from the start of the shot until the changeover depth is reached. The “bottom” filters are used the rest of the time. Flag marker filters are used in the detection of the flag marker.

In a preferred embodiment of the current invention the actual gain of the amplifiers, the Preamp 130 and two Gain Stages 136 and 138, is determined by the start gain and end gain settings and the minimum and maximum gain settings. The amplifier gain with a start or end gain setting of 1 is equal to the minimum gain setting and the gain at a start or end gain setting of 10 equals the maximum gain. Minimum and maximum gains will be set when the Controller is initially setup and probably will not be changed by the user.

In a preferred embodiment of the current invention the fluid hit algorithm is a set of steps taken by the Signal Processor to find the reflection from the fluid surface. The background sound during the shot is filtered and a threshold is determined. The threshold is found by first tracking the instantaneous peak sound amplitude. Between peaks, this amplitude is “bled away” by the decay rate. The threshold is the average of previous peaks multiplied by the threshold multiplier.

The characteristics of the threshold can be changed by the operator to work in a particular well by changing the decay rate, averaging time, and threshold multiplier.

Last, in a preferred embodiment of the current invention each sound sample is compared to the current threshold. When the sound amplitude reaches the threshold in a negative direction, the fluid reflection has been found. Flag marker detection works in the same way but looks for a positive level and uses its own variables.

The depth calculation performed by the Controller is Depth=Time to hit×(Velocity/2)

Operating of the Controller Unit

In a preferred embodiment of the current invention the Controller Unit 200 is in a protective case of approximately 8×8×5 inches. After opening the Latch 235 and lifting the Lid 231 of the Controller Unit 200, various selection pushbutton controls will be available for usage. The USB Port 225 can be connected to any USB receiver for uploading programming and well control information and for downloading of stored data.

In a preferred embodiment of the current invention there are various momentary pushbuttons on the Controller Unit 200. Just to the right side of the LED Display 203 are two Arrow Pushbuttons 208 and 209 used to adjust the display increments upward or downward in conjunction with most of the other pushbuttons on the controller unit 200. To the right side of these arrow buttons are 3 Power Pushbuttons, Power On 205, Controller On 206, and Pumping On 207. Each of these pushbuttons can be used by pushing once for on and once again for off relating to their respective uses. These three pushbuttons are used in several ways mainly as status indicator bars. When the Power Indicator bar 205 is on it shows when there is adequate power to the Controller Unit 200. When this light is not illuminated it indicates that the power may be electively turned off by the user or the power source to the Controller may be interrupted. When the Controller On bar 206 is illuminated it indicates that the well is under the control of the Controller and the Controller is functioning normal. When the Controller On bar 206 is not illuminated it indicates that the Controller may have been electively turned off, the timed monitoring mode may have been selected, a malfunction may have been detected, or a low level indicator may have shut the Controller off and altered the pumping mode to slow down or turn off. When the Pumping On bar 207 is illuminated it indicates that the pump is turned on either electively or as a normal controller function. When it is not illuminated it indicates that the pumping action is off. This can be an elective function of the operator, the result of a detected malfunction, the result of a high or low fluid alarm, or as the result of the timed monitoring mode having been previously selected.

In a preferred embodiment of the current invention the first Pushbutton on the upper left side just below the LED Display 203 is the Feet from surface to fluid at ‘Pump Turn-On Button’ 210. It is used to adjust the depth in feet from the surface of the well to when the Fluid level raises enough to turn on the pump. This is done by pressing the button once and then adjusting the display reading using the up or down arrow buttons to reach the desired footage from the surface to the fluid when the pump is turned on or the speed of a variable speed pump is increased by a predetermined increment. If these adjustments are not initiated within 5 seconds the current setting will revert. The next button below is the Feet from surface to fluid at ‘Pump Turn-Off Button’ 211. It is used to adjust the depth in feet from the surface of the well to when the Fluid level lowers enough to turn off the pump. This is done by pressing the button once and then adjusting the display reading using the up or down arrow buttons to reach the desired footage from the surface to the fluid when the pump is turned off or the speed of a variable speed pump is decreased by a predetermined increment. The next button is the Feet from surface for ‘High Fluid Alarm Button’ 212. It is used as a safety point to warn when the fluid level has reached beyond an acceptable high level for normal operations. This is done by pressing the button once and then adjusting the display reading using the up or down arrow buttons to reach the desired distance from the surface at which this alarm is activated. This is usually set at a level well above the turn on or speed increase fluid level setting. Depending on the pumping type this alarm may shut down the pumping action for circumstances such as a broken rod from a surface pump jack. There are also programming options where the pump can be turned off using the high fluid alarm. The next button is the Feet from surface for ‘Low Fluid Alarm Button’ 213. It is used as a safety point to warn when the fluid level has reached beyond an acceptable low level for normal operations. This is done by pressing the button once and then adjusting the display reading using the up or down arrow buttons to reach the desired distance. This setting is usually adjusted to a fluid level from surface somewhat below the pump turn off or speed decrease setting. This alarm as well as the high fluid alarm may activate a warning light and or buzzer placed in a visible location above or near the well controller as well as an alarm signal transmitted via any of the communications described herein. These alarms especially the low fluid alarm can also shut down all pumping action simultaneously with sounding the alarm. These alarms can also be useful in setting the times between soundings for both the pump turn on and speed increase and the pump turn off and speed decrease. To do this the alarms are set at the respective pump turn on and turn off levels thus providing a visible or remotely observable time at which the well fills or pumps down. This allows the user to set either from the controller panel or remotely the time between soundings which will perform the intended functions without making excessive or unneeded soundings. The next button is the ‘Acoustic Velocity in Feet/Second Button’ 214. It is used to adjust the acoustic velocity in feet/second. This is done by pressing the button once and then adjusting the display reading using the up or down arrow buttons to reach the desired distance. The acoustic velocity is normally determined automatically by the controller calculating from a known preset distance to a flag marker within the well to determine a corrected acoustic velocity immediately preceding the calculations for every fluid level. The next button below is the ‘View Current Well Pressure Button’ 215. It is used to view the current well pressure by pressing it once. The current well pressure will be immediately displayed on the LED Display 203 for 5 seconds. After the 5 seconds the LED Display 203 will revert to the previous display showing just before the View Current Well Pressure Button 215 was pressed. An additional function of this pushbutton is to reset the Controller Unit 200 to zero when a new Microphone Unit 34 is used at atmospheric pressure, or when the Microphone Unit 34 is located to a different altitude. The reset function is accomplished by exposing the Microphone Unit 34 to the atmosphere and pressing the View current well pressure button 215 four times rapidly. Set 0 will appear in the LED readout for 5 seconds and automatically calculate the pressure to 0 then return the controller to the normal operating mode. The next button below is the ‘View Previous Readings Button’ 216. It is used to view the previous sounding's date, time, fluid level, and well pressure by pressing once for each item. By pressing once more the ‘View Previous Readings Button’ 216 will move further back to the second most previous sounding and scroll through its date, time, fluid level, and well pressure with each press of the button. It will continue in like manner through the last 100 soundings at which time it will then revert to the most recent sounding or unless a pause of 5 seconds is exceeded at which time it will revert to the most recent sounding and reading. For immediate current information a user can press the ‘Fire Shot to start reading or timer pushbutton’ 222 physically or remotely and the controller will initiate an immediate sounding. When this sounding is completed the ‘View Previous Readings’ button 216 will then display this new sounding information. The next button below is the ‘Access Additional Modes Button’ 217. It is used to access other useful modes already installed in the controller and modes and updates that may be installed in the future. To access additional modes press the button 217 once or more to select the desired mode. The LED Display 203 will immediately read the selected Mode. The individually selected mode can be adjusted pressing the up and down Arrow Buttons 208 and 209 to turn the function on or off or to adjust the setting of the function. The next button is directly to the right side of the ‘Fluid at pump turn on button’ 210. It is the ‘Time between Readings When Well is Filling Button’ 218. It is used to set the time between soundings when the well is filling. This is done by pressing the button once. The current or default time will be displayed on the LED Display 203. This setting can then be adjusted by using the up and down arrow buttons 208 and 209 to adjust the desired setting. The next button below the time between readings when filling button 218 is the ‘Time between Readings When the Well is Pumping Button’ 219. It is used to set the time between soundings when the well is pumping. This is done by pressing the button once. The current or default time will be displayed on the LED Display 203. This setting can then be adjusted by using the up and down arrow buttons 208 and 209 to adjust the desired setting. The next button below is the ‘Total Well Depth to be monitored Button’ 220. It is used to adjust the total well depth to be monitored by pressing it once and then using the up and down arrow buttons 208 and 209 to adjust the total well depth in feet as seen on the LED Display 203. The next button below is the ‘Begin or End the Timed Monitoring Mode Button’ 221. It is used to begin or end the timed monitoring mode. The sequence of this mode may be a fixed unit of time or a preset variable proportion. This is done by pressing button 221 once and then using the up and down arrow buttons 208 and 209 to adjust the readout upward to set a fixed time between soundings and downward below 1 minute to display various curves and sequences for a variable time between soundings. The next and last button below is the ‘Fire extra shot for reading Now Button’ 222. It is used by pressing once when an immediate current sounding and reading is desired. The current sounding and reading will be initiated and displayed as it happens on the LED display 203. It will stay posted for 5 seconds after it is completed and then the display will revert to whatever was displayed just prior to the shot. In a preferred embodiment of the current invention all of the pushbuttons listed above have indicator lights relating to their usage which illuminate in their active mode.

In a preferred embodiment of the current invention the functions of the menu pushbuttons are shown in Table 2:

TABLE 2
(All Pushbuttons are Momentary On/Off)
Menu for Controller Unit

| Button | Mode | Default | Start/Adjust |
|---|---|---|---|
| 205 | On/Off | Off | Push Once for On/Once |
| | | | for Off |
| 206 | On/Off | Switch/Indicator | Push Once for On/Once |
| | | | for Off |
| 207 | On/Off | Switch/Indicator | Push Once for On/Once |
| | | | for Off |
| 208/9 | Up-Down | Stand-by | Push/Hold to Advance |
| | | | or Decline Reading |
| 210 | Up-Down | Pump turn On | Push = On 5 sec, |
| | | Position | adjust with Arrow Knobs |
| 211 | Up-Down | Pump turn Off | Push = On 5 sec, |
| | | Position | adjust with Arrow Knobs |
| 212 | Up-Down | High Fluid Alarm | Push = On 5 sec, |
| | | Position | adjust with Arrow Knobs |
| 213 | Up-Down | Low Fluid Alarm | Push = On 5 sec, |
| | | Position | adjust with Arrow Knobs |
| 214 | Up-Down | Default Setting | Push = On 5 sec, |
| | | | adjust with Arrow Knobs |
| 215 | PSI | Current Reading/Set | Push = View 5 sec, |
| | | | tap 4 times = Set 0 |
| 216 | View | Previous Readings | Push Repeatedly = |
| | | | View past shot info |
| 217 | View | Scroll/Access | Push = On 5 sec, |
| | | | adjust with Arrow Knobs |
| 218 | Up-Down | Time When Well | Push = On 5 sec, |
| | | is Filling | adjust with Arrow Knobs |
| 219 | Up-Down | Time When Well | Push = On 5 sec, |
| | | is Pumping | adjust with Arrow Knobs |
| 220 | Up-Down | View/Set | Push = On 5 sec, |
| | | | adjust with Arrow Knobs |
| 221 | Up-Down/ | Timed Monitoring | Push-On/Off, adjust |
| | Select | | with Arrow Knobs |
| 222 | Signal | Stand-by | Push Once to Start a |
| | | | Shot/Sequence |

In a preferred embodiment of the current invention there are various properties, modes, and settings all of which can be entered as defaults. These perimeters are typically installed in the Control Unit 200 flash memory either manually through the USB port 225 or through the Network Interface 156 to a wireless or SCADA network system. The following table is a list of some of the Control Perimeters that can be added Control Unit 200:

TABLE 3
Control Perimeters

Total well depth to be monitored
Beginning gain intensity
Ending gain intensity
Frequency changeover
Default acoustic velocity
Flag marker upper setting
Flag marker lower setting
Flag marker known depth
Flag marker application frequency
Flag marker threshold
Fluid level threshold default
Feet from surface to fluid at pump turn on/speed increase
Feet from surface to fluid at pump turn off/speed decrease
Feet from surface for high fluid alarm
Feet from surface for low fluid alarm and automatic shut down
Acoustic velocity
Time between readings when well is filling
Time between readings when well is pumping
Set or End timed monitoring mode

Obtaining Initial Default Program Settings

In a preferred embodiment of the current invention the initial default program settings are installed into the Controller Unit 200 after the desired well has been analyzed using a portable well surveyor, such as the Acoustic Generator and Surveyor Unit, disclosed in Guion et al., which is interfaced to a graphical computer software program for analysis. From this analysis the ideal sounding criteria and other programmable settings are determined and downloaded into the Controller Unit 200 through the USB port 225 or through the Network Interface 156. On-site field adjustments and changes to the Controller Unit 200 settings can then be made using the various pushbuttons as listed above in Table 2.

In addition specific well information and statistics can be installed into the preferred embodiment of the current invention. Typically this information relates to but is not limited to the pump depth, and any well anomalies such as liner tops, changeovers, etc. commonly referred to as “Markers” and explained in the “Automated Marker Finder and the Corrected Acoustic Velocity Calculator” section of Guion et al.

Firing Sequence

This process is initiated when the user presses the ‘Fire shot to start reading or timer’ button 222 on a powered up fully attached well controller. This will send a signal from the Controller Unit 200 to the Acoustic Generator 0 or similar device. For the Acoustic Generator 0 the signal charges the pressure chamber in the acoustic generator with a predetermined gas pressure for about 2 seconds. Just before the Acoustic Generator 0 is charged the Controller Unit 200 reads the current well pressure from a pressure transducer 77 in the Acoustic Generator 0 to transfer it to the readout log. At the end of this charging cycle and just before this charge is released into the well a pressure reading of the charge itself is sent to the well controller. This pressure reading will also be transferred to the readout log. If the charge is inadequate according to a preset level for a quality sounding, the controller will shut down or slow down the well pump and send a warning signal via wireless, SCADA, etc to a remote receiver.

The shot is fired into the well and the microphone is activated for feedback readings. At the end of the readings (predetermined by the well depth to be monitored) the shot information is instantly calculated. First the flag marker is located at a known depth and this information is used to instantly recalculate the acoustic velocity. With the recalculated acoustic velocity the current fluid level is determined and then logged into the shot file. All of the results of the fluid level hit and any other wanted information are entered into this shot file and is instantly retrievable using one or more of the pushbuttons.

Result Actions

The controller calculations will determine results and those results will trigger automatic functions relating to the preset desired production perimeters. If the results of the shot are within the preset perimeters, the well will continue to pump normally. When the results show the fluid level too low for normal operations the pump is slowed down by a preset amount or the pump is turned off and the well is allowed to refill. When the results show the fluid level has risen above a preset depth in the well the pump is then turned back on or the pumping speed is increased.

Alarm Actions

When something malfunctions or breaks the fluid level will raise or lower and the high or low fluid alarm will be triggered. Either of these alarms will shut the pump down. Simultaneously a warning signal is sent via wireless/ SCADA/ etc. to a remote receiver.

Changing the Settings

When older equipment is replaced in a well with new or more efficient equipment the shot timing, shot cycle, or safety alarm settings can be readjusted to accommodate the increased efficiency.

What is claimed is:

1. A well pump controller unit comprising a central processing unit programmed to control the operations of a precise well measuring device and programmed to control the pump rate of a well pump based on said results, said results including at least one marker signal of a known frequency range within a predetermined time interval as generated by said precise well measuring device.

2. A well pump controller unit as in claim 1 wherein said central processing unit is further programmed to calculate the acoustic velocity based on the time of firing said precise well measuring device, the time of detecting the marker signal, and a distance measurement.

3. A well pump controller unit as in claim 2 wherein said distance measurement is the distance between the top of the well and a physical marker.

4. A well pump controller unit as in claim 3 wherein said central processing unit is further programmed to detect a second marker signal after the firing said precise well measuring device.

5. A well pump controller unit as in claim 4 wherein said central processing unit is further programmed to calculate the distance between the acoustic gun and the second physical marker based on the time of firing the precise well measuring device, the time of detecting the second marker signal, and the acoustic velocity.

6. A well pump controller unit as in claim 5 wherein said second physical marker is the fluid level at the bottom of the well.

7. A method for continuously controlling a well pump comprising:
a. generating results from a precise well measuring device, said results including at least one marker signal of a known frequency range within a predetermined time interval;
b. controlling the pump rate of a well pump based on said results; and
c. repeating steps a. and b. above.

8. A method as in claim 7 wherein the acoustic velocity of the well is calculated based on the time of firing said precise well measuring device, the time of detecting the marker signal, and a distance measurement.

9. A method as in claim 8 wherein said distance measurement is the distance between said precise well measuring device and a physical marker.

10. A method as in claim 9 is further programmed to calculate the distance between said precise well measuring device and the second physical marker based on the time of firing the precise well measuring device, the time of detecting the second marker signal, and the acoustic velocity.

11. A method as in claim 10 wherein said second physical marker is the fluid level at the bottom of the well.
